(19) United States
(12) Patent Application Publication
(10) Pub. No.: US 2008/0250441 A1
(43) Pub. Date: Oct. 9, 2008

(54) Messaging for communications systems

(76) Inventors: Ajay Sharma, Irvine, CA (US); Bernard Debbasch, Newport Beach, CA (US)

Correspondence Address: Peter A. Businger, Esq.;Suite 205, 373 Park Avenue, Scotch Plains, NJ, 07076-1145, US

(21) Appl. No.: 11/784,476

(22) Filed: Apr. 6, 2007

(51) Int. Cl. H04N 7/16

(52) U.S. Cl. 725/13

(57) ABSTRACT

Interactive televised programs rely heavily on audience feedback via Short Message Service (SMS) provided by mobile/cellular network. On a polling prompt which opens a clocked “polling window”, a TV viewer enters his/her feedback message into a mobile/cell phone for transmission over a communications network such as GSM (Global System for Mobile Communications) or CDMA (Code Division Multiple Access). Especially in a residential setting, for an IP (Internet Protocol)-enabled TV or STB (Set-Top Box), message entry can be facilitated by messaging capability from a hand-held control device for the TV or the STB.

### TECHNICAL FIELD

The present invention is concerned with techniques for message transmission in communications systems and, more particularly, for transmission of audience feedback from viewers of televised programs.

### BACKGROUND OF THE INVENTION

Interactive televised programs such as American Idol and Big Brother, for example, rely heavily on audience feedback via Short Message Service (SMS) provided by mobile/cellular network. On a polling prompt which opens a clocked “polling window”, a TV viewer enters his/her feedback message into a mobile/cell phone for transmission over a communications network such as GSM (Global System for Mobile Communications) or CDMA (Code Division Multiple Access). Typically, such message entry takes place in a viewer's residence, using his/her cell phone.

### SUMMARY OF THE INVENTION

It is noted that, especially in a residential setting, communications access from the cell phone to the network may be impaired on account of poor coverage due to weak signal strength. Furthermore, timely SMS message entry may be hampered as the viewer may find it cumbersome to get a hold of his/her cell phone, so that, in a worst case scenario, the polling window may be missed. Moreover, use of a cell phone may be limited to a specific individual, with other family members then being precluded from entering a message unless the individual is present with the phone.

As the mobile network becomes an extension to the Internet using technologies such as GA (General Access), I-WLAN (Wireless Local Area Network) and IMS (IP (Information Processing) Multimedia Subsystem), a more convenient and efficient feedback mechanism can be provided to the viewer. For an IP-enabled TV or STB (Set-Top Box), the ability of sending messages can be embedded natively in the device itself. If this is the case, the functionality can be triggered by a hand-held control device, e.g. a remote control of TV or STB, or can be accessed via alternative means of providing feedback, such as a touch screen or a speech-to-text synthesizer, for example.

### BRIEF DESCRIPTION OF THE DRAWINGS

FIG. 1 is a schematic which illustrates messaging functionality in accordance with a preferred embodiment of the invention.

FIG. 2 is a schematic which illustrates a modular interface between a remote control module and the Internet, suitable for Generic Access (GA) to the Internet.

### DETAILED DESCRIPTION

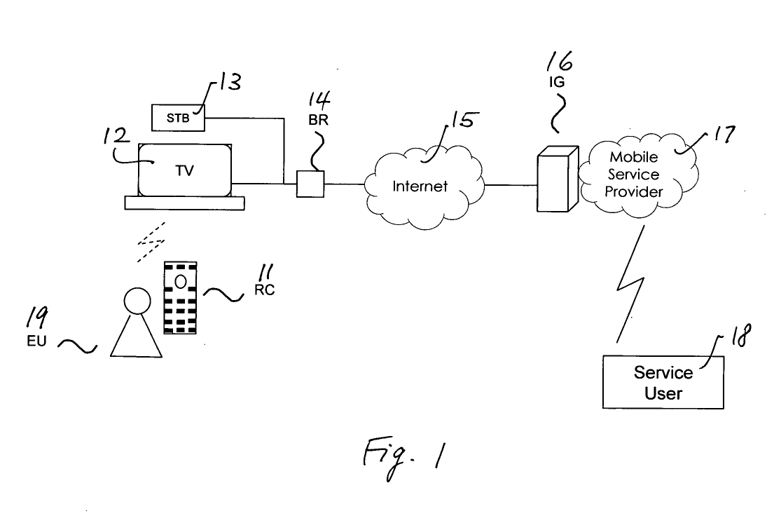

FIG. 1 shows a remote control 11 for a television set 12 or a set-top box 13 connected to the Internet 15 via a residential broadband gateway 14. The gateway 14 can make use of conventional telephone service, cable, DSL (Digital Subscriber Line) or wireless/mobile/cellular service. A mobile service provider or cellular network 17 is connected to the internet 15 using a technology-specific internet gateway 16. A conventional interface can serve for message forwarding from the mobile service provider 17 to a final message or service user 18.

In operation, in response to a prompt displayed on TV 12, a subscriber 19 can use his/her remote control 11 for submitting feedback without requiring recourse to a cell phone. The feedback is communicated via the TV 12 set or set-top box 13, the Internet 15 and the cellular network 17 to the service user 18.

Multiple technologies such as Generic Access (GA), Interworking WLAN (I-WLAN) and IP Multimedia Subsystem (IMS) can be used to access the cellular network via the Internet.

For activation of feedback functionality of the hand-held device 11, the device may be equipped with a dedicated key which effectively turns the remote control's keypad into a keypad of a mobile phone. As a telling caption for the key, “SMS” might be shown on or next to the key, for example. Alternatively, without a separate key, feedback functionality can be provided by an available combination of regular key strokes such as “*#”, for example.

Instead of keying, where a control device for a TV set or a set-top box is suitably equipped, a feedback signal can be entered via a touch screen on the control device. Or it may be the TV set proper that is equipped with a touch screen, for receiving feedback input without a separate control device.

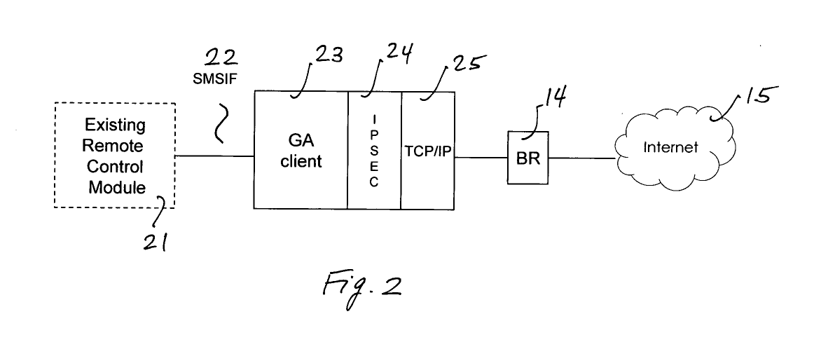

FIG. 2 illustrates a modular arrangement for GA wherein, ahead of the broadband gateway 14, the SMS interface 22 of a remote control module 21 is integrated with a GA client 23. The remote control module 21 can be either that of a television set 12 or of a set-top box 13. The GA client 23 interfaces with IPSEC (Internet Protocol Security) module 24 and TCP/IP (Transmission Control Protocol with Internet Protocol) module 25 for establishing a secure link, effectively turning the remote control 11 into a cell phone connected to the service user 18.

In operation, when a feedback signal or message is entered via the remote control 11, a circuit within the remote control module 21 converts the feedback into a corresponding text message. The text can be echoed as a screen display for verification by the subscriber 19 and, on the subscriber 19 signaling approval for submission, the remote control module 21 activates the GA client 23. The GA client 23 sets up a secure channel with the cellular provider 17, using customer credentials. Upon successful setup, the GA client 23 submits the text message as SMS for transmission to the service user 18. A text-based acknowledgement is sent back to the remote control module 21 for suitable display to the subscriber 19 in an asynchronous manner.

1. A TV system comprising TV apparatus and adapted for
(a) receiving feedback from a viewer of a TV program being displayed by the TV apparatus, and
(b) transmitting the feedback over a cellular network.

2. The TV system of claim 1, wherein the feedback is received on sensing touch.

3. The TV system of claim 2, wherein the feedback is received on a keypad.

4. The TV system of claim 2, wherein the feedback is received on a touch screen.

5. The TV system of claim 1, wherein the feedback is received on sensing sound.

6. The TV system of claim 1, wherein the feedback is received by the TV apparatus.

7. The TV system of claim 1, further comprising a control device for remote control of functionality of the TV apparatus, and wherein the feedback is received by the control device.

8. The TV system of claim 1, further comprising a set-top box for the TV apparatus, and wherein the feedback is received by the set-top box.

9. The TV system of claim 1, further comprising a residential broadband gateway, and wherein the feedback is received by the residential broadband gateway.

10. The TV system of claim 1, wherein the TV apparatus is equipped for communicating with the cellular network according to a protocol selected from GA, I-WLAN and IMS protocols.

11. The TV system of claim 9, wherein the set-top box is equipped for communicating with the cellular network according to a protocol selected from GA, I-WLAN and IMS protocols.
